(19) United States
(12) Patent Application Publication
(10) Pub. No.: US 2013/0179642 A1
(43) Pub. Date: Jul. 11, 2013

(54) Non-Allocating Memory Access with Physical Address

(71) Applicants: Erich James Plondke, Austin, TX (US); Ajay Anant Ingle, Austin, TX (US); Lucian Codrescu, Austin, TX (US)

(72) Inventors: Erich James Plondke, Austin, TX (US); Ajay Anant Ingle, Austin, TX (US); Lucian Codrescu, Austin, TX (US)

(73) Assignee: QUALCOMM INCORPORATED, San Diego, CA (US)

(21) Appl. No.: 13/398,927

(22) Filed: Feb. 17, 2012

Related U.S. Application Data
(60) Provisional application No. 61/584,964, filed on Jan. 10, 2012.

(51) Int. Cl. G06F 12/08; G06F 12/10

(52) U.S. Cl. 711/142; 711/206; 711/141; 711/E12.026; 711/E12.061

(57) ABSTRACT

Systems and methods for performing non-allocating memory access instructions with physical address. A system includes a processor, one or more levels of caches, a memory, a translation look-aside buffer (TLB), and a memory access instruction specifying a memory access by the processor and an associated physical address. Execution logic is configured to bypass the TLB for the memory access instruction and perform the memory access with the physical address, while avoiding allocation of one or more intermediate levels of caches where a miss may be encountered.

### CLAIM OF PRIORITY UNDER 35 U.S.C. §119

The present application for patent claims priority to Provisional Application No. 61/584,964 entitled “Non-Allocating Memory Access with Physical Address” filed Jan. 10, 2012, and assigned to the assignee hereof and hereby expressly incorporated by reference herein.

### FIELD OF DISCLOSURE

Disclosed embodiments are directed to memory access operations using physical addresses. More particularly, exemplary embodiments are directed to memory access instructions designed to bypass virtual-to-physical address translation and avoid allocating one or more intermediate levels of cache.

### BACKGROUND

Virtual memory, as is well known in the art, can be addressed by virtual addresses. The virtual address space is conventionally divided into blocks of contiguous virtual memory addresses, or “pages.” While programs may be written with reference to virtual addresses, a translation to physical address may be necessary for the execution of program instructions by processors. Page tables may be employed to map virtual addresses to corresponding physical addresses. Memory management units (MMUs) are conventionally used to look up page tables which hold virtual-to-physical address mappings, in order to handle the translation. Because contiguous virtual addresses may not conveniently map to contiguous physical addresses, MMUs may need to walk through several page tables (known as “page table walk”) for a desired translation.

MMUs may include hardware such as a translation lookaside buffer (TLB). A TLB may cache translations for frequently accessed pages in a tagged hardware lookup table. Thus, if a virtual address hits in a TLB, the corresponding physical address translation may be reused from the TLB, without having to incur the costs associated with a page table walk.

MMUs may also be configured to perform page table walks in software. Software page table walks often suffer from the limitation that the virtual address of a page table entry (PTE) is not known, and thus it is also not known if the PTE is located in one of associated processor caches or main memory. Thus, the translation process may be tedious and time consuming.

The translation process may suffer from additional drawbacks associated with a “hypervisor” or virtual machine manager (VMM). The VMM may allow two or more operating systems (known in the art as “guests”), to run concurrently on a host processing system. The VMM may present a virtual operating platform and manage the execution of the guest operating systems. However, conventional VMMs do not have visibility into cacheability types, such as “cached” or “uncached,” of memory elements (data/instructions) accessed by the guests. Thus, it is possible for a guest to change the cacheability type of memory elements, which may go unnoticed by the VMM. Further, the VMM may not be able to keep track of virtual-to-physical address mappings which may be altered by the guests. While known architectures adopt mechanisms to hold temporary mappings of virtual-to-physical addresses specific to the guests, such mapping mechanisms tend to be very slow.

Additional drawbacks may be associated with debuggers. Debug software or hardware may sometimes use instructions to query the data value present at a particular address in a processing system being debugged. Returning the queried data value may affect the cache images, depending on cacheability types of the associated address. Moreover, page table walks or TLB accesses may be triggered on account of the debuggers, which may impinge on the resources of the processing system.

Accordingly, there is a need in the art to avoid aforementioned drawbacks associated with virtual-to-physical address translation in processing systems.

### SUMMARY

Exemplary embodiments of the invention are directed to systems and method for memory access instructions designed to bypass virtual-to-physical address translation and avoid allocating one or more intermediate levels of caches.

For example, an exemplary embodiment is directed to a method for accessing memory comprising: specifying a physical address for the memory access; bypassing virtual-to-physical address translation; and performing the memory access using the physical address.

Another exemplary embodiment is directed to a memory access instruction for accessing memory by a processor, wherein the memory access instruction comprises: a first field corresponding to an address for the memory access; a second field corresponding to an access mode; and a third field comprising operation code configured to direct execution logic to: in a first mode of the access mode, determine the address in the first field to be a physical address; bypass virtual-to-physical address translation; and perform the memory access with the physical address. The operation code is further configured to direct the execution logic to: in a second mode of the access mode, determine the address in the first field to be a virtual address; perform virtual-to-physical address translation from the virtual address to determine a physical address; and perform the memory access with the physical address.

Another exemplary embodiment is directed to a processing system comprising: a processor comprising a register file; a memory; a translation look-aside buffer (TLB) configured to translate virtual-to-physical addresses; and execution logic configured to, in response to a memory access instruction specifying a memory access and an associated physical address: bypass virtual-to-physical address translation for the memory access instruction; and perform the memory access with the physical address.

Another exemplary embodiment is directed to a system for accessing memory comprising: means for specifying a physical address for the memory access; means for bypassing virtual-to-physical address translation; and means for performing the memory access using the physical address.

Another exemplary embodiment is directed to a non-transitory computer-readable storage medium comprising code, which, when executed by a processing system, causes the processing system to perform operations for accessing memory, the non-transitory computer-readable storage medium comprising: code for specifying a physical address for the memory access; code for bypassing virtual-to-physical address translation; and code for performing the memory access using the physical address.

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates processing system 100 configured to implement exemplary memory access instructions according to exemplary embodiments.

FIG. 2 illustrates a logical implementation of an exemplary memory access instruction specifying a load.

FIG. 3 illustrates an exemplary operational flow of a method of accessing memory according to exemplary embodiments.

FIG. 4 illustrates a block diagram of a wireless device that includes a multi-core processor configured according to exemplary embodiments.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Exemplary embodiments relate to processing systems comprising a virtually addressed memory space. Embodiments may comprise instructions and methods which specify a physical address instead of a virtual address. The exemplary memory access instruction may be a load or a store. As will be described in detail, the exemplary memory access instructions may simplify software page table walks, improve VMM functions, and make debugging easier.

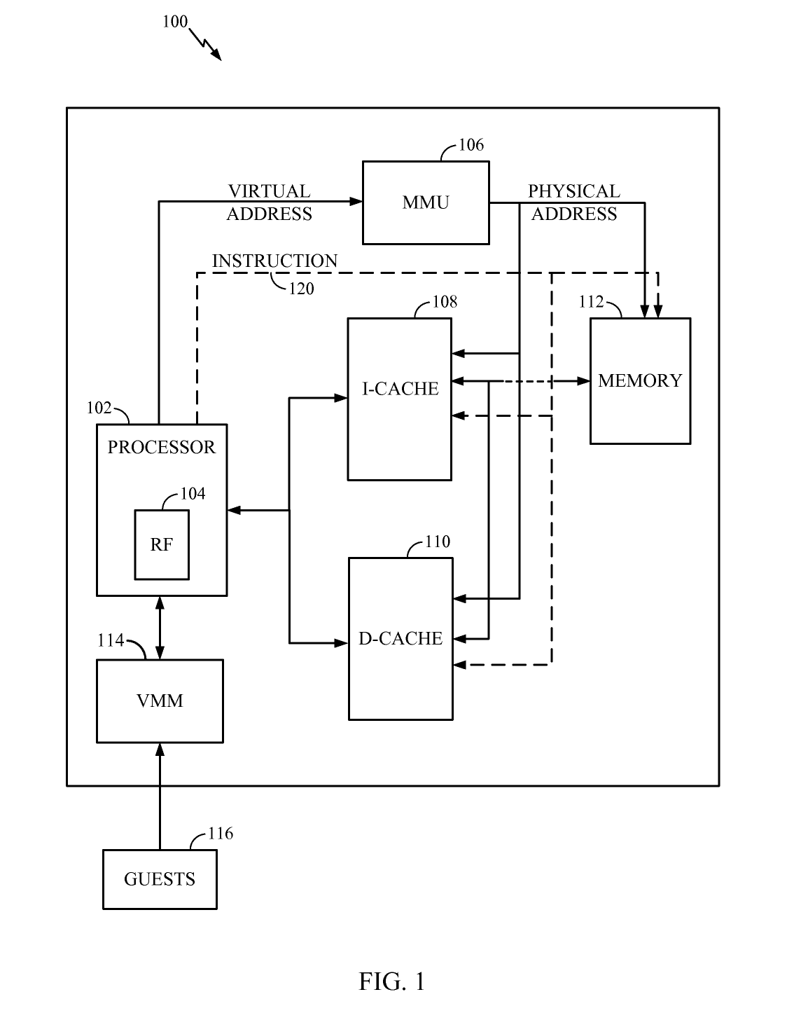

With reference now to FIG. 1, an exemplary processing system 100 is illustrated. Processing system 100 may comprise processor 102, which may be a CPU or a processor core. Processor 102 may comprise one or more execution pipelines (not shown) which may support one or more threads, one or more register files (collectively depicted as register file 104), and other components as are well known in the art. Processor 102 may be coupled to local (or L1) caches such as I-cache 108 and D-cache 110, as well as one or more higher levels of caches, such as L2 cache, etc (not explicitly shown). The caches may be ultimately in communication with main memory such as memory 112. Processor 102 may interact with MMU 106 to obtain translations of virtual-to-physical addresses in order to perform memory access operations (loads/stores) on the caches or memory 112. MMU 106 may include a TLB (not shown) and additional hardware/software to perform page table walks. A virtual machine manager, VMM 114 is shown to be in communication with processor 102. VMM 114 may support one or more guests 116 to operate on processing system 100. The depicted configuration of processing system 100 is for illustrative purposes only, and skilled persons will recognize suitable modifications and additional components and connections to processing system 100 without departing from the scope of disclosed embodiments.

With continuing reference to FIG. 1, an exemplary memory access instruction 120 will now be described. Instruction 120 is illustrated in FIG. 1 by means of dashed lines representing communication paths which may be formed in executing the instruction. Skilled persons will recognize that implementation of instruction 120 may be suitably modified to fit particular configurations of processing system 100. Further, reference is made herein, to “execution logic” which has not explicitly illustrated, but will be understood to generally comprise appropriate logic blocks and hardware modules which will be utilize to perform the various operations involved in the execution of instruction 120 in processing system 100 according to exemplary embodiments. Skilled persons will recognize suitable implementations for such execution logic.

In one exemplary embodiment, instruction 120 is a load instruction, wherein the load instruction may directly specify the physical address for the load, instead of the virtual address as known in conventional art. By specifying the physical address for the load, instruction 120 avoids the need for a virtual-to-physical address translation, and thus, execution of instruction 120 may avoid accessing MMU 106 (as shown in FIG. 1). Thus, execution of instruction 120 may proceed by directly querying caches, such as I-cache 108 and D-cache 110 using the physical address for the load.

In one scenario, the physical address for the load may hit in one of the caches. For example, execution of instruction 120 may first query local caches, and if there is a miss, execution may proceed to a next level cache, and so on, until there is a hit. Regardless of which cache level generates a hit, the data value corresponding to the physical address for the load is retrieved from the hitting cache, and may be directly delivered to register file 104.

In the scenario wherein the physical address for the load does not hit in any of the caches, the corresponding data value may be fetched from main memory 112. However, this will be treated as an uncached load or a non-allocating load. In other words, the caches will not be updated with the data value following a miss. In one example of a debugger (not shown) performing debug operations on processing system 100, instruction 120 may be generated following a load request for the physical address by the debugger. The above exemplary execution of instruction 120 can be seen to leave the cache images unperturbed by the debugger's request because of the non-allocating nature of instruction 120. In comparison to conventional implementations, processing system 100 may thus remain free from disruption of normal operations on account of a debugger affecting cache images.

In another exemplary embodiment, instruction 120 may be a store instruction, wherein the store instruction may directly specify the physical address for the store, instead of a virtual address as known in conventional art. Similar to operation of the load instruction as described above, the store instruction may query local caches first, and if there is a hit, a store may be performed. At least two varieties of store operations may be specified by the operation code of instruction 120—write-through and write-back. In a write-through store, caches such as I-cache 108 and D-cache 110, may be queried with the physical address and in the case of a hit, the next higher level of cache hierarchy, and ultimately, main memory, memory 112, may also be queried and updated. On the other hand, for a write-back store, in the case of a hit the store operation ends without proceeding to the higher levels of cache hierarchy.

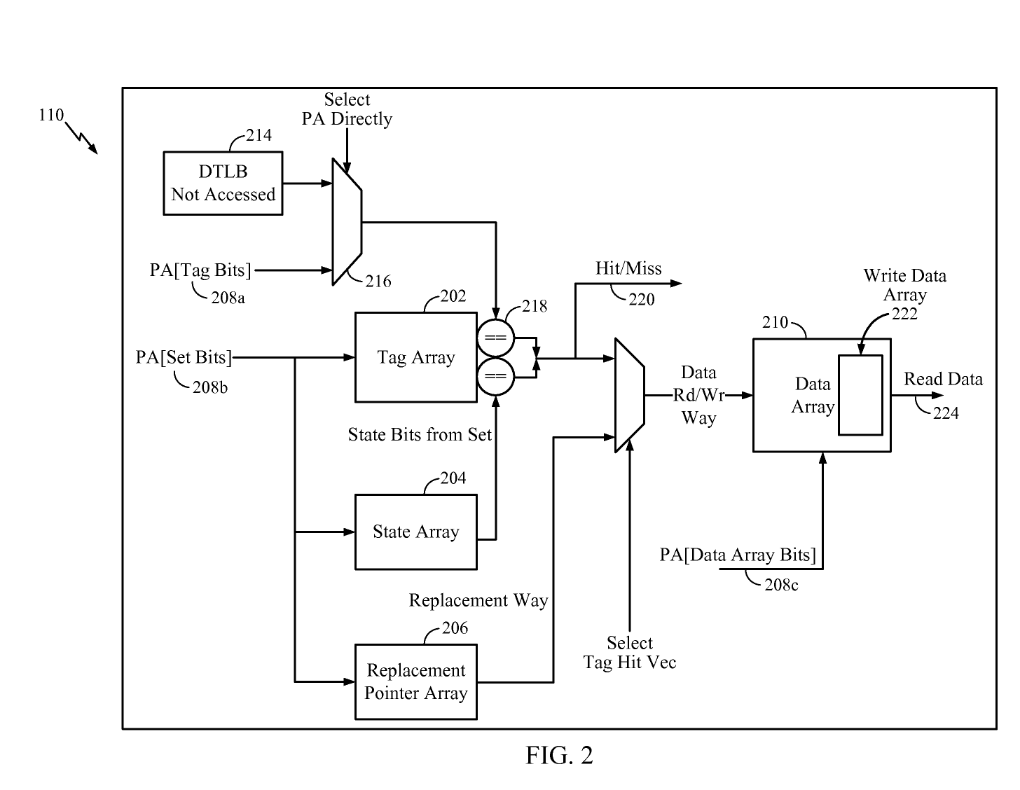

For both write-back and write-through stores, if a miss is encountered, the store may proceed to querying a next level cache with the physical address, and thereafter, main memory 112 if necessary. However, a miss will not entail cache allocation in exemplary embodiments, similar to loads. A dedicated buffer or data array may be included in some embodiments for such non-allocating store operations, as will be further described with reference to FIG. 2.

With reference now to FIG. 2, an exemplary hardware implementation of instruction 120 is illustrated. An expanded view of a cache, such as D-cache 110 is shown to comprise component arrays: data array 210 which stores data values; tag array 202 which comprises selected bits of physical addresses of corresponding data stored in data array 210; state array 204 which stores associated state information for the corresponding set; and replacement pointer array 206 which stores associated way information for any allocating load or store operation which may require the way to be replaced for the corresponding allocation. Although not accessed for the execution of instruction 120, DTLB 214 may hold virtual-to-physical address translations for frequently accessed addresses. DTLB 214 may be included for example in MMU 106.

Firstly, with regard to loads, when instruction 120 for an exemplary load is received for processing by processor 102, the physical address field specified in instruction 120 for the load is retrieved. The physical address field is parsed for the fields: PA [Tag Bits] 208a corresponding to the bits associated with the tag for the load address; PA [Set Bits] 208b corresponding to the set associated with the load address; and PA [Data Array Bits] 208c corresponding to the location in data array 210 for a load address which hits in D-cache 110. In one implementation, PA [Data Array Bits] 208c may be formed by a combination of PA [Set Bits] 208b and a line offset value to specify the location of a load address. For example, data array 210 may comprise cacheline blocks. The line offset value may be used to specify desired bytes of data located in the cacheline blocks based on the physical address for the load and size of the load, such as byte, halfword, word, doubleword, etc.

Execution of instruction 120 may also comprise asserting the command Select PA Directly 216, which causes selector 216 to directly choose PA [Tag Bits] 208a over bits which may be derived from DTLB 214 and may also suppress a virtual-to-physical address translation by the DTLB 214. Tag array 202 and state array 204 may be accessed using PA [Set Bits] 208b, and comparators 218 may then compare whether the tag bits, PA [Tag Bits] 208a, are present in tag array 202, and if their state information is appropriate (e.g. “valid”). If comparators 218 generate a hit on hit/miss line 220, confirming that the load address is present and valid, then PA [Data Array Bits] 208c and associated way information derived from replacement pointer array 206 may jointly be used to access data array 210 to retrieve the desired data value for the exemplary load instruction specified by instruction 120. The desired data value may then be read out of read data line 224 and may be transferred directly to processor 102, for example, into register file 104.

In the above implementation of querying and retrieving data from D-cache 110 in accordance with exemplary embodiments of instruction 120 specifying a load, cache images, such as that of D-cache 110, may remain unchanged. In other words, regardless of whether there was a hit or a miss, tag array 202, state array 204, replacement pointer array 206, and data array 210 are not altered.

Turning now to stores, the operation is similar, for both write-through and write-back stores. For example, if instruction 120 specifies a store of data to a physical address, then in one implementation, local cache, D-cache 110 may be queried for both write-through and write-back stores, and if the physical address is found, then the data may be written to a dedicated array, write data array 222, which may be included in data array 210 as shown in FIG. 2. In the case of write-through stores, the operation may proceed to querying and updating a next higher level cache (not shown) as described above, while in the case of a write-back the operation may end with writing write data array 222.

For both write-through and write-back stores, if the physical address is not found, i.e. there is a miss, then any updates to the arrays of D-cache 110 may be skipped, and the data may be written directly to the physical address location in memory 112. In other words, the store may be treated as a non-allocating store. Such exemplary store operations specified by instruction 120 may be used in debug operations, for example, by a debugger.

Similar to the load/store instructions which may be specified by instruction 120 for data which may pertain to D-cache 110, exemplary embodiments may also include load/store instructions for instruction values pertaining to I-cache 108. For example, a physical address fetch instruction may be specified, which may be executed in like manner as instruction 120 described above. The physical address fetch instructions may be used to locate an instruction value corresponding to a physical address in a non-allocating manner. Thus, I-cache 108 may first be queried. If a hit is encountered, the desired fetch operation may proceed by fetching the instruction value from the physical address specified in the instruction. If a miss is encountered, allocation of I-cache 108 may be skipped and execution may proceed to query any next level cache and ultimately main memory 112 if required.

While the above description has been generally directed to bypassing MMU 106/DTLB 214 for every instance of instruction 120, a variation of instruction 120 may be additionally or alternatively included in some embodiments. Without loss of generality, a variation of instruction 120 may be designated as instruction 120′ (not shown), wherein instruction 120′ may comprise specified mode bits to control bypass of MMUs or TLBs. For example, in a first mode defined by mode bits of instruction 120′, the address value specified in instruction 120′ may be treated as a virtual address and MMU 106 may be accessed for a virtual-to-physical address translation. On the other hand, in a second mode defined by mode bits of instruction 120′, the address value may be treated as a physical address and MMU 106 may be bypassed.

Accordingly, in some embodiments, instruction 120′ may comprise the following fields. A first field of instruction 120′ may correspond to an address for the memory access which may be determined to be a virtual address or a physical address based on the above-described modes. A second field of instruction 120′ may correspond to an access mode to select between the above first mode or the second mode; and a third field of instruction 120′ may comprise an operation code (or OpCode as known in the art) of instruction 120′. If the access mode is set to the first mode, the execution logic may determine the address in the first field to be a physical address and bypass virtual-to-physical address translation in MMU 106/DTLB 214 and perform the memory access with the physical address. On the other hand, the access mode is set to the second mode, the execution logic may determine the address in the first field to be a virtual address and perform any required virtual-to-physical address translation from the virtual address to determine a physical address by invoking MMU 106/DTLB 214 and then proceed to perform the memory access with the physical address.

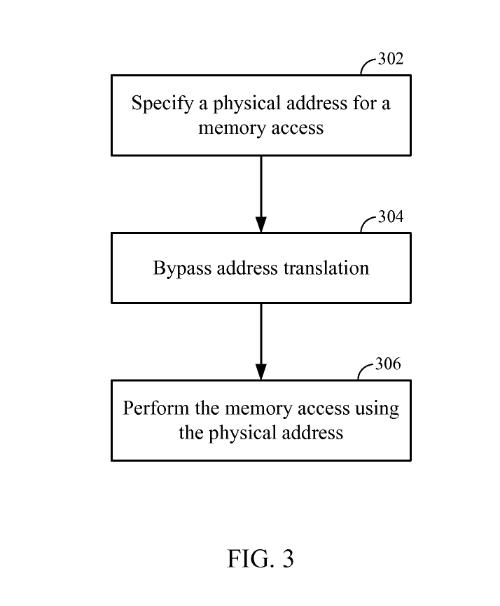

It will be appreciated that embodiments include various methods for performing the processes, functions and/or algorithms disclosed herein. For example, as illustrated in FIG. 3, an embodiment can include a method for accessing memory (e.g. D-cache 210) comprising: specifying a physical address (e.g. instruction 120 specifying a physical address comprising bits 208a, 208b, and 208c) for the memory access—Block 302; bypassing address translation (e.g. bypassing DTLB 214)—Block 304; and performing the memory access using the physical address (e.g. selector 216 configured to select physical address bits 208a, 208b, and 208c instead of virtual-to-physical address translation from DTLB 214)—Block 306.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

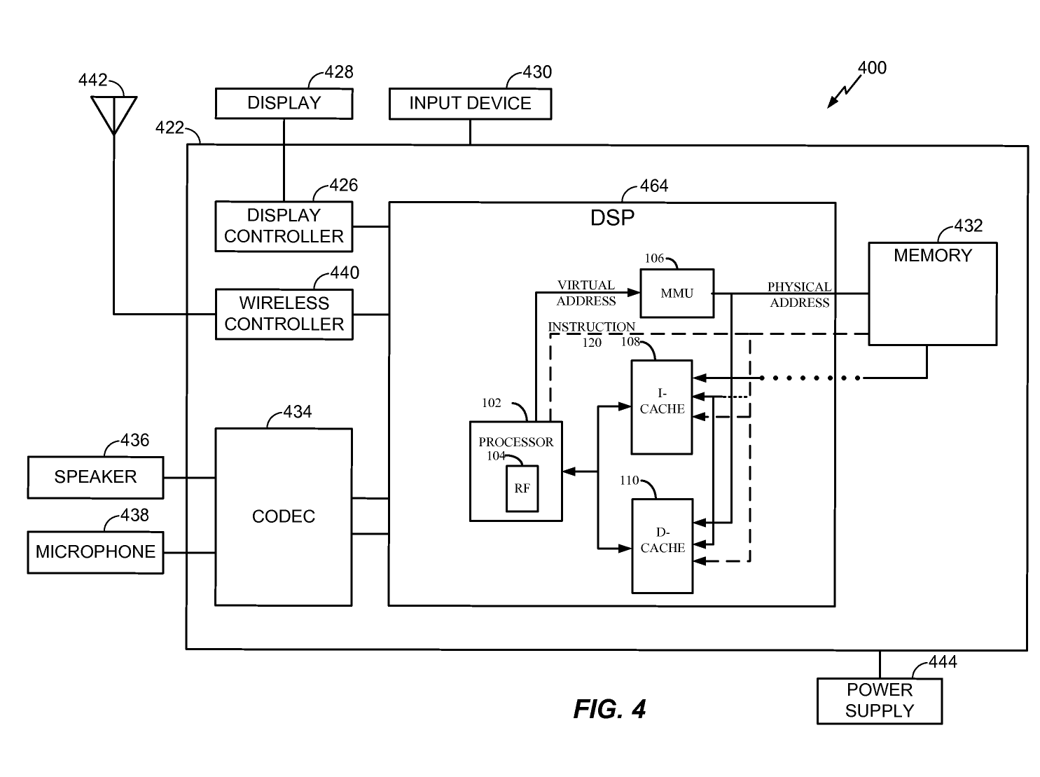

Referring to FIG. 4, a block diagram of a particular illustrative embodiment of a wireless device that includes a multi-core processor configured according to exemplary embodiments is depicted and generally designated 400. The device 400 includes a digital signal processor (DSP) 464. Similar to processing system 100, DSP 464 may include MMU 106, processor 102 comprising register file 104, I-cache 108, and D-cache 110 of FIG. 1, which may be coupled to memory 432 as shown. The device 400 may be configured to execute instructions 120 and 120′ without performing a virtual-to-physical address translation as described in previous embodiments. FIG. 4 also shows display controller 426 that is coupled to DSP 464 and to display 428. Coder/decoder (CODEC) 434 (e.g., an audio and/or voice CODEC) can be coupled to DSP 464. Other components, such as wireless controller 440 (which may include a modem) are also illustrated. Speaker 436 and microphone 438 can be coupled to CODEC 434. FIG. 4 also indicates that wireless controller 440 can be coupled to wireless antenna 442. In a particular embodiment, DSP 464, display controller 426, memory 432, CODEC 434, and wireless controller 440 are included in a system-in-package or system-on-chip device 422.

In a particular embodiment, input device 430 and power supply 444 are coupled to the system-on-chip device 422. Moreover, in a particular embodiment, as illustrated in FIG. 4, display 428, input device 430, speaker 436, microphone 438, wireless antenna 442, and power supply 444 are external to the system-on-chip device 422. However, each of display 428, input device 430, speaker 436, microphone 438, wireless antenna 442, and power supply 444 can be coupled to a component of the system-on-chip device 422, such as an interface or a controller.

It should be noted that although FIG. 4 depicts a wireless communications device, DSP 464 and memory 432 may also be integrated into a set-top box, a music player, a video player, an entertainment unit, a navigation device, a personal digital assistant (PDA), a fixed location data unit, or a computer. A processor (e.g., DSP 464) may also be integrated into such a device.

Accordingly, an embodiment of the invention can include a computer readable media embodying a method for accessing memory using physical address and bypassing a MMU configured for virtual-to-physical address translation. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for accessing memory comprising:
specifying a physical address for the memory access;
bypassing virtual-to-physical address translation; and
performing the memory access using the physical address.

2. The method of claim 1 wherein the memory access is a load request initiated by a processor, the method further comprising:
traversing one or more levels of caches configured between the processor and the memory for data associated with the physical address of the load request; and
returning the data directly to the processor from the cache level or memory where the data is first found, without modifying the states of any intermediate cache levels wherein the load request encounters a miss.

3. The method of claim 2 further comprising: avoiding allocation of the data in the intermediate cache levels wherein the load request encounters a miss.

4. The method of claim 1, further comprising: avoiding look-up of page attributes associated with the physical address.

5. The method of claim 1 wherein the memory access is a store request initiated by a processor, the method further comprising:
traversing one or more levels of caches configured between the processor and the memory for the physical address of the store request; and
writing the data associated with the store request directly from the processor to the cache level or memory where the physical address is first found, without modifying the states of any intermediate cache levels wherein the store request encounters a miss.

6. The method of claim 5, further comprising avoiding allocation of any intermediate cache levels wherein the store request encounters a miss.

7. The method of claim 5, wherein the store request is executed as a write-through operation such that if the physical address is first found in a first cache level, the method further comprises writing the data to any cache level present between the first cache level and the memory.

8. The method of claim 1, wherein the physical address corresponds to registers in a register file.

9. A memory access instruction for accessing memory by a processor, wherein the memory access instruction comprises:
a first field corresponding to an address for the memory access;
a second field corresponding to an access mode; and
a third field comprising operation code configured to direct execution logic to:
in a first mode of the access mode, determine the address in the first field to be a physical address;
bypass virtual-to-physical address translation; and
perform the memory access with the physical address.

10. The memory access instruction of claim 9, wherein the operation code is configured to direct the execution logic to:
in a second mode of the access mode, determine the address in the first field to be a virtual address;
perform virtual-to-physical address translation from the virtual address to determine a physical address; and
perform the memory access with the physical address.

11. A processing system comprising:
a processor comprising a register file;
a memory;
a translation look-aside buffer (TLB) configured to translate virtual-to-physical addresses; and
execution logic configured to, in response to a memory access instruction specifying a memory access and an associated physical address:
bypass virtual-to-physical address translation for the memory access instruction; and
perform the memory access with the physical address.

12. The processing system of claim 11 wherein the memory access is a load, and the execution logic is configured to:
traverse one or more levels of caches configured between the processor and the memory for data associated with the physical address of the load request; and
return the data directly to a register corresponding to the physical address in the register file, from the cache level or memory where the data is first found, without modifying the states of any intermediate cache levels wherein the load request encounters a miss.

13. The processing system of claim 12 wherein the execution logic is further configured to avoid allocation of the data in the intermediate cache levels wherein the load request encounters a miss.

14. The processing system of claim 11, wherein the execution logic is further configured to avoid look-up of page attributes associated with the physical address.

15. The processing system of claim 11 wherein the memory access is a store, and the execution logic is configured to:
traverse one or more levels of caches configured between the processor and the memory for the physical address of the store request; and
write the data associated with the store request directly from the processor to the cache level or memory where the physical address is first found, without modifying the states of any intermediate cache levels wherein the store request encounters a miss.

16. The processing system of claim 15, wherein the execution logic is further configured to avoid allocation of any intermediate cache levels wherein the store request encounters a miss.

17. The processing system of claim 15, wherein the memory access is further specified as a write-through operation such that if the physical address is first found in a first cache level, the execution logic is configured to write the data to any cache level present between the first cache level and the memory.

18. The processing system of claim 11 integrated in a semiconductor die.

19. The processing system of claim 11, integrated into a device selected from the group consisting of a set top box, music player, video player, entertainment unit, navigation device, communications device, personal digital assistant (PDA), fixed location data unit, and a computer.

20. A system for accessing memory comprising:
means for specifying a physical address for the memory access;
means for bypassing virtual-to-physical address translation; and
means for performing the memory access using the physical address.

21. The system of claim 20 wherein the memory access is a load request initiated by a processor, the system further comprising:
means for traversing one or more levels of caches configured between the processor and the memory for data associated with the physical address of the load request; and
means for returning the data directly to the processor from the cache level or memory where the data is first found, without modifying the states of any intermediate cache levels wherein the load request encounters a miss.

22. The system of claim 20 wherein the memory access is a store request initiated by a processor, the system further comprising:
means for traversing one or more levels of caches configured between the processor and the memory for the physical address of the store request; and
means for writing the data associated with the store request directly from the processor to the cache level or memory where the physical address is first found, without modifying the states of any intermediate cache levels wherein the store request encounters a miss.

23. A non-transitory computer-readable storage medium comprising code, which, when executed by a processing system, causes the processing system to perform operations for accessing memory, the non-transitory computer-readable storage medium comprising:
code for specifying a physical address for the memory access;
code for bypassing virtual-to-physical address translation; and
code for performing the memory access using the physical address.
